(19) United States
(12) Patent Application Publication
(10) Pub. No.: US 2024/0118446 A1
(43) Pub. Date: Apr. 11, 2024

(54) Wedge-Cut Backing Of Acoustic Transducer For Improved Attenuation

(71) Applicant: Halliburton Energy Services, Inc., Houston, TX (US)

(72) Inventors: Jichun Sun, Singapore (SG); Jing Jin, Singapore (SG); Xiang Wu, Singapore (SG); Christopher Michael Jones, Katy, TX (US); Gennady Koscheev, Houston, TX (US)

(73) Assignee: Halliburton Energy Services, Inc., Houston, TX (US)

(21) Appl. No.: 17/961,823

(22) Filed: Oct. 7, 2022

(51) Int. Cl. G01V 1/52; G01V 1/02; G01V 1/04

(52) U.S. Cl. CPC G01V 1/52; G01V 1/04; G01V 1/159; G01V 2001/526

(57) ABSTRACT

Systems and methods of the present disclosure relate to signal attenuation for acoustic logging tools. An acoustic logging tool includes acoustic transducers. Each acoustic transducer includes a body, a piezoelectric element disposed on a first end of the body to receive or transmit at least one signal, and a wedge-cut disposed on an opposite end of the body. The wedge-cut defines a sloped portion operable to attenuate signals.

### BACKGROUND

Acoustic transducers operate by emitting acoustic signals and detecting subsequent reflections of the acoustic signals. Absorbing materials are placed at the back of a piezoelectric ceramic or composite, also referred to as a piezoelectric element, to attenuate energy traveling backward. When the attenuation is insufficient, due to limited quality or limited length of the material, the bottom of the transducer may reflect backward-propagating energy that is then picked by up the piezoelectric element, resulting in signal degradation if the piezoelectric element acts as both a source and a receiver.

### BRIEF DESCRIPTION OF THE DRAWINGS

These drawings illustrate certain aspects of some examples of the present disclosure and should not be used to limit or define the disclosure.

FIG. 1 illustrates an acoustic logging tool in a wireline configuration, in accordance with examples of the present disclosure;

FIG. 2 illustrates an acoustic logging tool in a drilling configuration, in accordance with examples of the present disclosure;

FIG. 3A illustrates a close-up view of the acoustic logging tool in a pitch-catch configuration, in accordance with examples of the present disclosure;

FIG. 3B illustrates a close-up view of the acoustic logging tool in a pulse-echo configuration, in accordance with examples of the present disclosure;

FIG. 3C illustrates a close-up view of an acoustic transducer with a wedge-cut/sloped portion, in accordance with examples of the present disclosure;

FIG. 4A illustrates a perspective view of a backing body of an acoustic transducer with a wedge-cut, in accordance with examples of the present disclosure;

FIG. 4B illustrates a cross-section of the backing body of FIG. 4A, in accordance with examples of the present disclosure;

FIG. 5 illustrates a perspective view of a variation of a backing body of an acoustic transducer with the wedge-cut, in accordance with examples of the present disclosure;

FIG. 6 illustrates a perspective view of another variation of a backing body of an acoustic transducer with the wedge-cut, in accordance with examples of the present disclosure;

FIG. 7 illustrates reflection reduction due to the wedge-cut backing of an acoustic transducer, in accordance with examples of the present disclosure; and

FIG. 8 illustrates an operative sequence for improved attenuation in acoustic logging tools, in accordance with examples of the present disclosure.

### DETAILED DESCRIPTION

The present disclosure relates to acoustic transducers that include a wedge-cut to the bottom of the backing material (e.g., absorbing material) to reduce backward-propagating energy. In some examples, this wedge-cut shape can reduce interfering reflections by a factor of at least 4. Other shapes, such as cones, pyramids, and randomly ridged ends, do not reduce interfering reflections to this degree.

At high temperature and pressure, the backing material may lose some of its absorbing capacity. While a longer backing body can be utilized to increase attenuation, this occupies valuable space in a logging tool. The wedge-cut backing occupies a minimum amount of space, leading to cost savings and improved signal quality. In particular examples, the wedge-cut (e.g., an asymmetric reflector) may be used at the bottom of the backing material to reduce the recorded reflection in 3 ways: (1) the energy arriving at the piezoelectric element is out of phase, partially canceling each other via destructive interference; (2) driving more energy to the inactive portion at the top of the backing/backing material; and (3) increasing the distance traveled by the reflected energy in the backing material. The exact slope and position of the cut depends on the specification of the transducer (e.g., shape and size of the backing material, size of piezoelectric element) and can be selected with the aid of simulations and/or experimentation.

A wedge-cut may be made at the end of a cylindrical backing. In some examples, the recorded reflection in the wedge-cut backing material is only ⅙ of that in a flat-end backing material, peak-to-peak. The body of the backing does not have to be cylindrical. For example, the horizontal cross-section of the body may be an oval, rectangle, polygon, or combination of shapes. The body can also be of non-uniform shapes, such as a frustum. Furthermore, the piezoelectric element does not have to be at the center of the top of the backing material. For example, the piezoelectric element may not be positioned at the center, and the backing is laterally elongated. In this scenario, the extra backing volume at the side consumes most of the reflected energy and the recorded reflection is reduced even further.

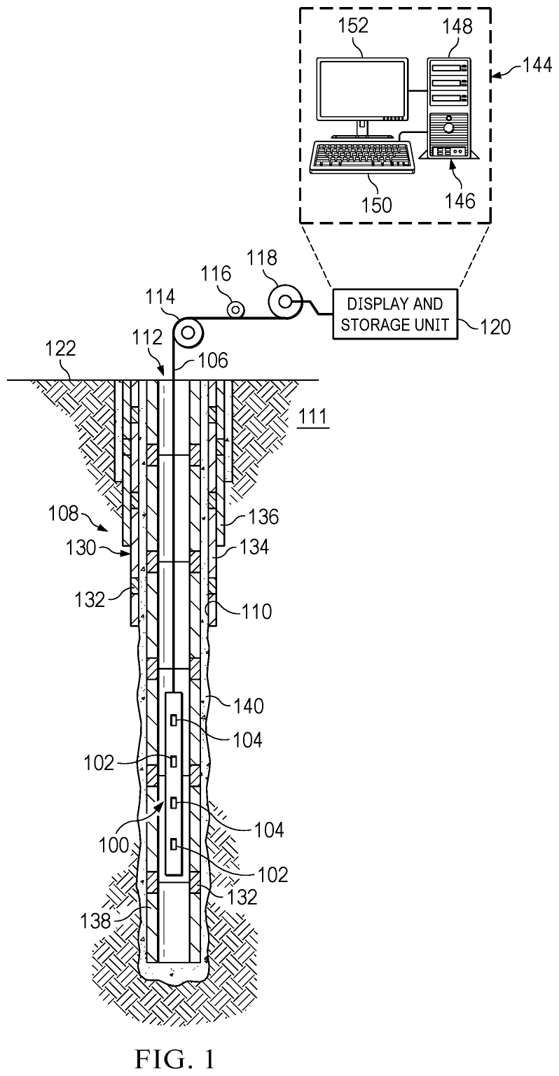

FIG. 1 illustrates an operating environment for an acoustic logging tool 100, in accordance with examples of the present disclosure. It should be noted that while FIG. 1 generally depicts a land-based operation, those skilled in the art may recognize that the principles described herein are equally applicable to subsea operations that employ floating or sea-based platforms and rigs, without departing from the scope of the disclosure.

As illustrated, the acoustic logging tool 100 may include at least one transmitter 102 (e.g., an acoustic transducer) and at least one receiver 104 (e.g., an acoustic transducer). Any suitable transmitter and receiver may be employed. The transmitters 102 and the receivers 104 may be disposed along the acoustic logging tool 100 in any suitable configuration. The acoustic logging tool 100 may be operatively coupled to a conveyance 106 (e.g., wireline, slickline, coiled tubing, pipe, downhole tractor, and/or the like) which may provide mechanical suspension, as well as electrical connectivity, for the acoustic logging tool 100. It should be understood that the configuration of acoustic logging tool 100 shown on FIG. 1 is merely illustrative and other configurations of the acoustic logging tool 100 may be used with the present techniques.

A conveyance 106 and the acoustic logging tool 100 may extend within a casing string 108 to a desired depth within the wellbore 110. The conveyance 106, which may include one or more electrical conductors, may exit a wellhead 112, may pass around a pulley 114, may engage an odometer 116, and may be reeled onto a winch 118, which may be employed to raise and lower the acoustic logging tool 100 in the wellbore 110. Signals recorded by the acoustic logging tool 100 may be stored on memory and then processed by a display and storage unit 120 after recovery of the acoustic logging tool 100 from the wellbore 110. Alternatively, signals recorded by the acoustic logging tool 100 may be transmitted to the display and storage unit 120 by way of the conveyance 106. The display and storage unit 120 may process the signals, and the information contained therein may be displayed for an operator to observe and store for future processing and reference. Alternatively, the signals may be processed downhole prior to receipt by display and storage unit 120 or both downhole and at a surface 122, for example. The display and storage unit 120 may also contain an apparatus for supplying control signals and power to the acoustic logging tool 100. The casing string 108 may extend from the wellhead 112 at or above ground level to a selected depth within the wellbore 110. The casing string 108 may comprise a plurality of joints 130 or segments of the casing string 108, each joint 130 being connected to the adjacent segments by a collar 132. There may be any number of layers in the casing string 108. For example, the layers may include a first casing 134 and a second casing 136.

FIG. 1 also illustrates a pipe string 138, which may be positioned inside of casing string 108 extending part of the distance down wellbore 110. Pipe string 138 may be production tubing, tubing string, casing string, or other pipe disposed within casing string 108. Pipe string 138 may comprise concentric pipes. It should be noted that concentric pipes may be connected by collars 132. The acoustic logging tool 100 may be dimensioned so that it may be lowered into the wellbore 110 through the pipe string 138, thus avoiding the difficulty and expense associated with pulling pipe string 138 out of wellbore 110. In examples, cement 140 may be disposed on the outside of pipe string 138. Cement 140 may further be disposed between pipe string 138 and casing string 108. It should be noted that cement 140 may be disposed between any number of casings, for example between the first casing 134 and the second casing 136.

In logging systems utilizing the acoustic logging tool 100, a digital telemetry system may be employed, wherein an electrical circuit may be used to both supply power to the acoustic logging tool 100 and to transfer data between the display and storage unit 120 and the acoustic logging tool 100. A DC voltage may be provided to the acoustic logging tool 100 by a power supply located above ground level, and data may be coupled to the DC power conductor by a baseband current pulse system. Alternatively, the acoustic logging tool 100 may be powered by batteries located within the downhole tool assembly, and/or the data provided by the acoustic logging tool 100 may be stored within the downhole tool assembly, rather than transmitted to the surface during logging.

In certain examples, operation and function of the acoustic logging tool 100 may be controlled at the surface 122 by a computer 144. As illustrated, the computer 144 may be a component of the display and storage unit 120. The computer 144 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, the computer 144 may be a personal computer, a network storage device, or any other suitable device and may vary in size, shape, performance, functionality, and price. The computer 144 may include a processing unit 146 (e.g., microprocessor, central processing unit, etc.) that may process EM log data by executing software or instructions obtained from a local non-transitory computer readable media 148 (e.g., optical disks, magnetic disks). The non-transitory computer readable media 148 may store software or instructions of the methods described herein. Non-transitory computer readable media 148 may include any instrumentality or aggregation of instrumentalities that may retain data and/or instructions for a period of time. The non-transitory computer readable media 148 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. At the surface 122, the computer 144 may also include input device(s) 150 (e.g., keyboard, mouse, touchpad, etc.) and output device(s) 152 (e.g., monitor, printer, etc.). The input device(s) 150 and output device(s) 152 provide a user interface that enables an operator to interact with the acoustic logging tool 100 and/or software executed by processing unit 146. For example, the computer 144 may enable an operator to select analysis options, view collected log data, view analysis results, and/or perform other tasks. In examples, the acoustic logging tool 100 and the computer 144 may be utilized to measure and process properties (e.g., signals) of a downhole environment.

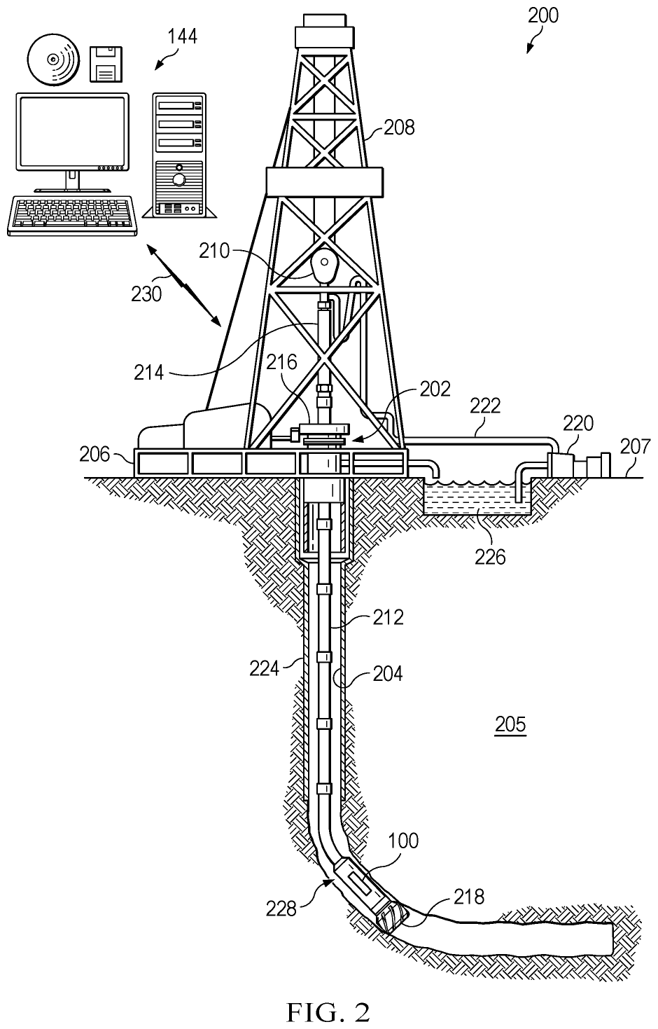

FIG. 2 illustrates an example of the acoustic logging tool 100 included in a drilling system 200, in accordance with examples of the present disclosure. It should be noted that while FIG. 2 generally depicts a land-based operation, those skilled in the art may recognize that the principles described herein are equally applicable to subsea operations that employ floating or sea-based platforms and rigs, without departing from the scope of the disclosure.

As illustrated, a borehole 204 may extend from a wellhead 202 into a subterranean formation 205 from a surface 207. The borehole 204 may include horizontal, vertical, slanted, curved, and other types of borehole geometries and orientations. A drilling platform 206 may support a derrick 208 having a traveling block 210 for raising and lowering a drill string 212. The drill string 212 may include, but is not limited to, drill pipe and coiled tubing, as generally known to those skilled in the art. A top drive or kelly 214 may support the drill string 212 as it may be lowered through a rotary table 216.

A drill bit 218 may be attached to the distal end of drill string 212 and may be driven either by a downhole motor and/or via rotation of drill string 212 from the surface 207. Without limitation, the drill bit 218 may include roller cone bits, PDC bits, natural diamond bits, any hole openers, reamers, coring bits, and the like. As the drill bit 218 rotates, it may create and extend borehole 204 that penetrates the subterranean formation 205. A pump 220 may circulate drilling fluid through a feed pipe 222 to the kelly 214, downhole through the interior of the drill string 212, through orifices in the drill bit 218, back to the surface 207 via an annulus 224 surrounding the drill string 212, and into a retention pit 226.

The drill string 212 may begin at wellhead 202 and may traverse borehole 204. The drill bit 218 may be attached to a distal end of the drill string 212 and may be driven, for example, either by a downhole motor and/or via rotation of the drill string 212 from the surface 207. The drill bit 218 may be a part of a bottom hole assembly 228 at a distal end of the drill string 212. The bottom hole assembly 228 may include the acoustic logging tool 100 via threaded connections, for example. As will be appreciated by those of ordinary skill in the art, bottom hole assembly 228 may be a measurement-while drilling (MWD) or logging-while-drilling (LWD) system.

Without limitation, the acoustic logging tool 100 may be connected to and/or controlled by the computer 144. Processing of information recorded may occur downhole and/or at the surface 207. Data being processed downhole may be transmitted to the surface 207 to be recorded, observed, and/or further analyzed. Additionally, the data may be stored in memory of the acoustic logging tool 100 while the acoustic logging tool 100 is disposed downhole.

In some examples, wireless communication may be used to transmit information back and forth between the computer 144 and the acoustic logging tool 100. The computer 144 may transmit information to the acoustic logging tool 100 and may receive, as well as process information recorded by the acoustic logging tool 100. In examples, while not illustrated, the bottom hole assembly 228 may include one or more additional components, such as an analog-to-digital converter, filter and amplifier, among others, that may be used to process the measurements of the acoustic logging tool 100 before they may be transmitted to the surface 207. Alternatively, raw measurements may be transmitted to the surface 207 from the acoustic logging tool 100.

Any suitable technique may be used for transmitting signals from the acoustic logging tool 100 to the surface 207, including, but not limited to, wired pipe telemetry, mud-pulse telemetry, acoustic telemetry, and electromagnetic telemetry. While not illustrated, the bottom hole assembly 228 may include a telemetry subassembly that may transmit telemetry data to the surface 207. Without limitation, an electromagnetic source in the telemetry subassembly may be operable to generate pressure pulses in the drilling fluid that propagate along the fluid stream to the surface 207. At the surface 207, pressure transducers (not shown) may convert the pressure signal into electrical signals for a digitizer (not illustrated). The digitizer may supply a digital form of the telemetry signals to the computer 144 via a communication link 230, which may be a wired or wireless link. The telemetry data may be analyzed and processed by the computer 144. The computer 144 may be employed for orientation determination and calibration of the acoustic logging tool 100.

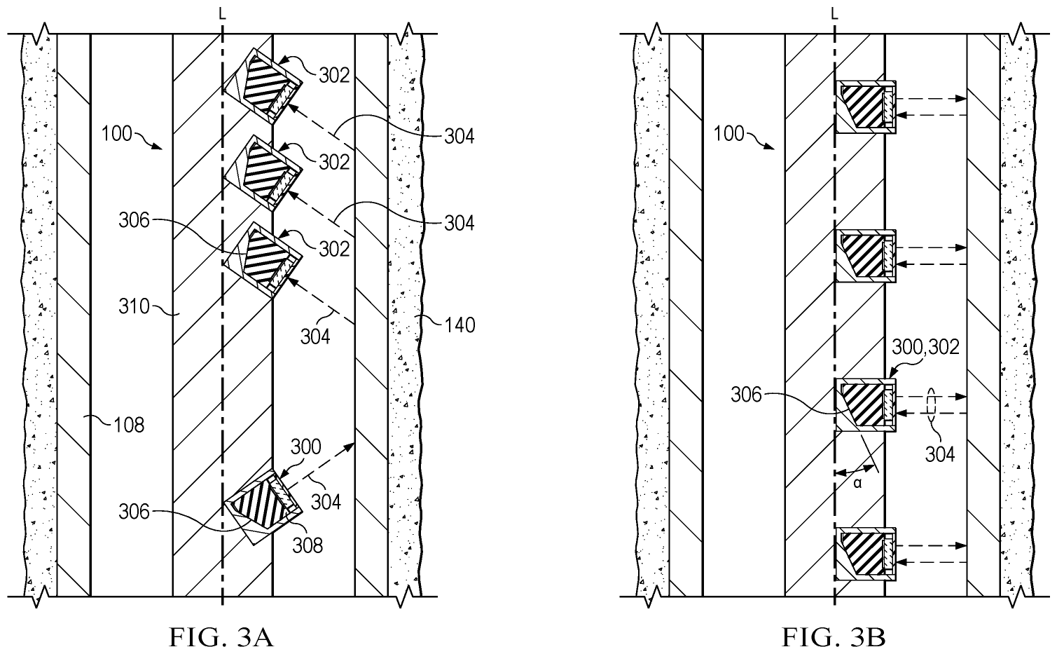

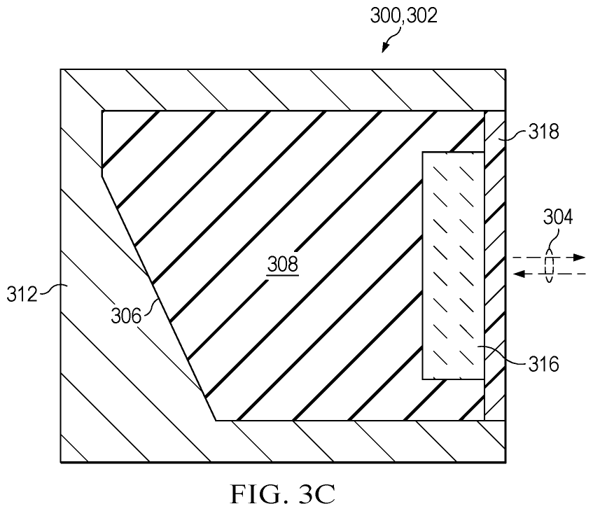

FIG. 3A illustrates a close-up view of the acoustic logging tool 100 in a pitch-catch configuration, in accordance with examples of the present disclosure. In this configuration, a transducer 300 operates as a source/transmitter and transducers 302 operate as receivers to receive the transmitted signal 304. Each of the transducers 300 and 302 includes a wedge-cut (e.g., sloped portion 306) to the bottom of the backing/absorbing material 308 to reduce backward-propagating energy (see FIG. 4). In some examples, the signals 304 are transmitted and/or received at a slope, due to the wedge-cut backing. In some examples, the sloped portion 306 extends in a direction that is parallel to a longitudinal axis L of the tool 100.

The sloped portion 306 of each acoustic transducer lies flush/adjacent against a portion (e.g., body 310) of the acoustic logging tool 100. The signals 304 may reflect off the casing 108 and/or the cement 140 (or formation). The sloped portion 306 may reduce interfering reflections by a factor of at least 4. In other examples, the sloped portion 306 may be angled relative to L, rather than parallel to L.

FIG. 3B illustrates a close-up view of the acoustic logging tool 100 in a pulse-echo configuration, in accordance with examples of the present disclosure. In this configuration, each transducer 300/302 may operate as both source/transmitter and receiver for signals 304. The sloped portion 306 of each transducer 300 may be at an angle α relative to the longitudinal axis L of the tool 100, such that transmission/reception of the signals 304 occurs perpendicular to the casing, cement, and/or formation. This angle may range from 20° to 80° for example.

FIG. 3C illustrates a close-up view of an acoustic transducer, in accordance with examples of the present disclosure. Each acoustic transducer 300/302 includes a protective shell 312. Surrounding the backing material 308 that includes the sloped portion 306. A piezoelectric element 316 (e.g., ceramic or composite) may transmit and/or receive the acoustic signals 304. A wearing layer 318 may be a protective cover for the piezoelectric element 316.

FIGS. 4A and 4B illustrate an acoustic transducer 400 with a backing body 402 that includes a wedge-cut, in accordance with examples of the present disclosure. As shown in the perspective view of FIG. 4A, the backing body 402 may include a cylindrical shape. It should be noted that the backing body 402 does not have to be cylindrical. The backing body 402 may include an oval, rectangle, polygon, or a combination of shapes. The body 402 can also be of non-uniform shapes, such as a frustum.

With additional reference to the cross-sectional view of the backing 400, as shown on FIG. 4B, a piezoelectric element interface 404 (e.g., composite or ceramic) may be disposed at a top 405 (e.g., a distal end facing away from the tool body as shown on FIG. 3) of the backing body 402, opposite to a bottom 406 (e.g., a proximal end adjacent to the tool body) of the body 402. The bottom 406 includes a sloped portion 408 and a flat portion 410. Furthermore, the piezoelectric element interface 404 does not have to be at a center of the top of the backing body 402, as shown.

It should be noted that the flat portion 410 may be removed (e.g., area reduced to zero) such that sloped portion 408 contacts a side wall 412 of the cylinder. The angle β of the wedge-cut may range from 20° to 80° degrees, relative to the flat portion 410, for example.

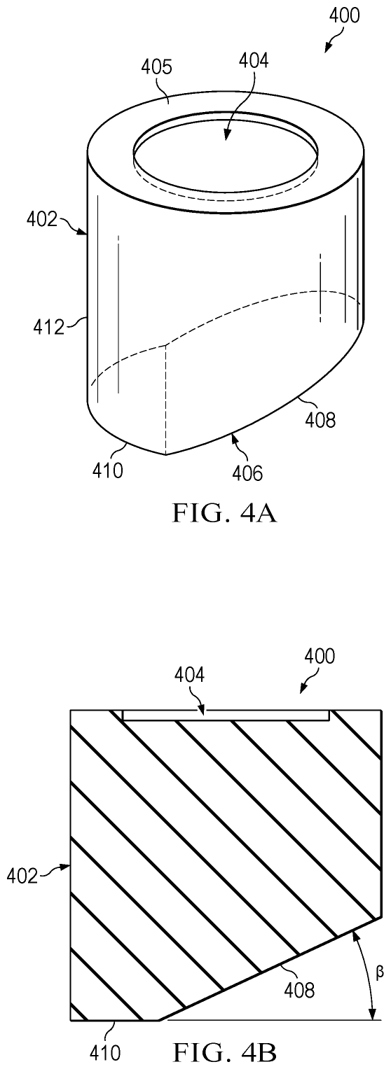

FIG. 5 illustrates an acoustic transducer 500 in which the piezoelectric element interface 502 is not at the center of the top 503. The backing body 505 is laterally elongated (e.g., elongated portion 506). The piezoelectric element interface 502 is off-center to define the elongated portion 506 extending from the piezoelectric element interface 502 to a side wall 508. In this configuration, the extra backing volume at the side consumes most of the reflected energy and the recorded reflection is reduced even further.

The piezoelectric element interface 502 (e.g., composite or ceramic) may be disposed at the top 503 (an end) of the backing body 505, opposite to a bottom 512 (an end) of the body 505. The bottom 512 includes a sloped portion 514 and a flat portion 516. It should be noted that the flat portion 516 may be removed (e.g., area reduced to zero) such that sloped portion 514 contacts the side wall 508.

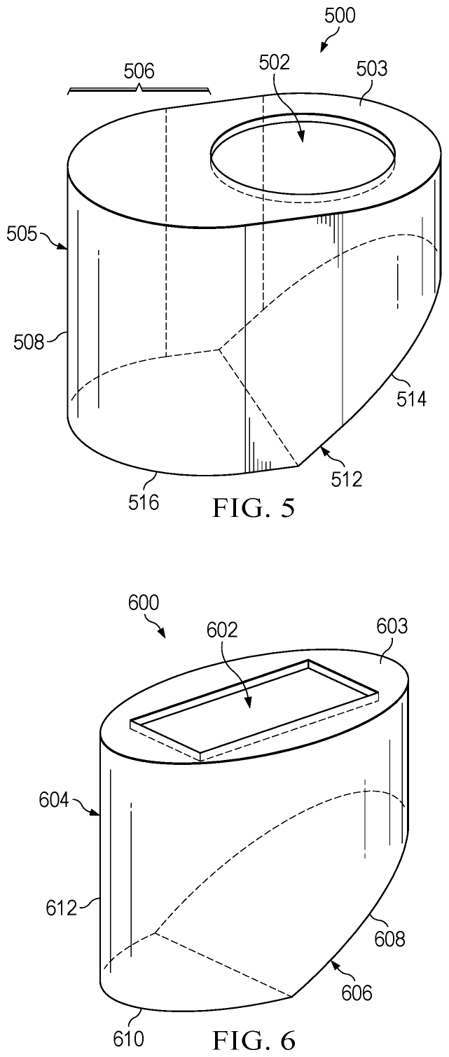

FIG. 6 illustrates an acoustic transducer 600 includes an oval horizontal cross-section and the piezoelectric element interface 602 is rectangular. A wedge-cut at the bottom of backing body 604 reduces the recorded reflection. The piezoelectric element interface 602 (e.g., composite or ceramic) may be disposed at a top 603 (an end) of the backing body 604, opposite to a bottom 606 (an end) of the body 604. The bottom 606 includes a sloped portion 608 and a flat portion 610. It should be noted that the flat portion 610 may be removed (e.g., area reduced to zero) such that sloped portion 608 contacts the side wall 612.

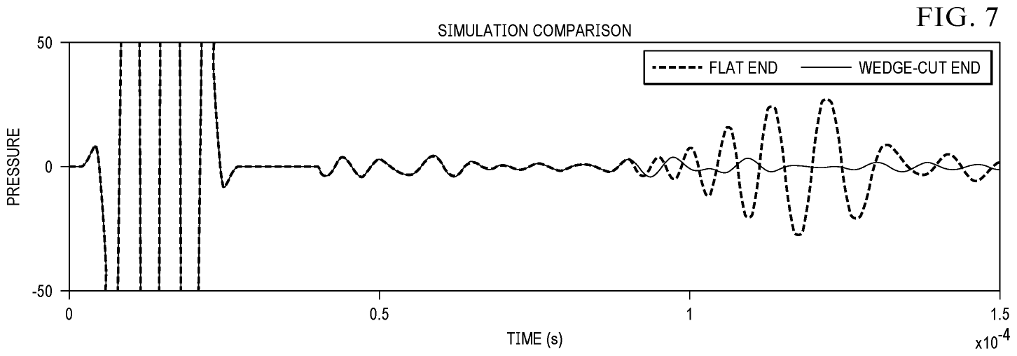

FIG. 7 illustrates that the recorded refection from the wedge-cut backing is substantially weaker as compared to the flat end backing, using the design of FIG. 4, for example. The recorded reflection in the wedge-cut backing case is only ⅙ of that of the flat-end case, peak to peak. As set forth above, the asymmetric reflector (e.g., wedge-cut) may be used at the bottom of the backing material to reduce the recorded reflection in 3 ways: (1) the energy arriving at the piezoelectric element is out of phase, partially cancelling each other via destructive interference; (2) driving more energy to the inactive portion at the top of the backing material; and (3) increasing the distance traveled by the reflected energy in the backing material. The exact slope and position of the cut depends on the specification of the transducer (e.g., shape and size of the backing material, size of piezoelectric element) and can be selected with the aid of simulations and/or experimentation.

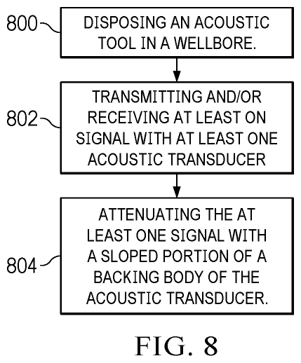

FIG. 8 illustrates an operative sequence to reduce a recorded reflection in a wellbore, in accordance with examples of the present disclosure. At step 800, an acoustic logging tool is disposed in a wellbore, as shown on FIGS. 1 and 2, for example. Each acoustic transducer of the tool includes a wedge-cut to the bottom of the backing (e.g., absorbing) material to reduce backward-propagating energy (see FIGS. 4A-6).

At step 802, at least one signal is transmitted/received by the acoustic transducer in a pitch-catch or a pulse-echo configuration. The signals may reflect off the formation and/or the casing (see FIG. 3).

At step 804, the sloped portion (wedge-cut shape) of the backing body of the transducer (see FIGS. 4A to 6), reduces (signal attenuation) interfering reflections by a factor of at least 4. For example, the asymmetric reflector may be used at the bottom of the backing material to reduce the recorded reflection in 3 ways: (1) the energy arriving at the piezoelectric element is out of phase, partially cancelling each other via destructive interference; (2) driving more energy to the inactive portion at the top of the backing material; and (3) increasing the distance traveled by the reflected energy in the backing material. The exact slope and position of the cut depends on the specification of the transducer (e.g., shape and size of the backing material, size of piezoelectric element) and can be selected with the aid of simulations and/or experimentation.

Accordingly, the systems and methods of the present disclosure reduce backward-propagating energy via a wedge-cut to the bottom of the backing/absorbing material. This wedge-cut shape can reduce interfering reflections by a factor of at least 4. The systems and methods may include any of the various features disclosed herein, including one or more of the following statements.

Statement 1. An acoustic logging tool comprising acoustic transducers, each acoustic transducer comprising: a body; a piezoelectric element disposed on a first end of the body to receive or transmit at least one signal; and a wedge-cut disposed on an opposite end of the body, the wedge-cut defining a sloped portion operable to attenuate the at least one signal.

Statement 2. The acoustic logging tool of the statement 1, wherein the piezoelectric element includes piezoelectric ceramics or composites.

Statement 3. The acoustic logging tool of the statement 1 or the statement 2, wherein the acoustic transducers are arranged in a pitch-catch configuration.

Statement 4. The acoustic logging tool of any one of the statements 1-3, wherein the acoustic transducers are arranged in a pulse-echo configuration.

Statement 5. The acoustic logging tool of any one of the statements 1-4, wherein the piezoelectric is disposed at a center of the first end.

Statement 6. The acoustic logging tool of any one of the statements 1-5, wherein the piezoelectric element is off-center on the first end.

Statement 7. The acoustic logging tool of any one of the statements 1-6, wherein the body includes an elongated portion extending from the piezoelectric element to a side wall of the body.

Statement 8. An acoustic logging tool comprising acoustic transducers, each acoustic transducer comprising: a body; a piezoelectric element disposed on a first end of the body to receive or transmit at least one signal, wherein the first end includes an elongated portion; and a wedge-cut disposed on an opposite end of the body, the wedge-cut defining a sloped portion operable to attenuate the at least one signal, the opposite end further including a flat portion adjacent to the sloped portion.

Statement 9. The acoustic logging tool of the statement 8, wherein the piezoelectric element includes piezoelectric ceramics.

Statement 10. The acoustic logging tool of the statement 8 or 9, wherein the acoustic transducers are arranged in a pitch-catch configuration.

Statement 11. The acoustic logging tool of any one of the statements 8-10, wherein the acoustic transducers are arranged in a pulse-echo configuration.

Statement 12. The acoustic logging tool of any one of the statements 8-11, wherein the piezoelectric element includes piezoelectric composites.

Statement 13. The acoustic logging tool of any one of the statements 8-12, wherein the piezoelectric element is disposed on a distal end of the acoustic transducer facing away from a body of the acoustic logging tool.

Statement 14. The acoustic logging tool of any one of the statements 8-13, wherein the sloped portion is adjacent to the body of the acoustic logging tool.

Statement 15. A method comprising: transmitting and/or receiving at least one acoustic signal with acoustic transducers, each acoustic transducer comprising a body; a piezoelectric element disposed on a first end of the body and a wedge-cut disposed on an opposite end of the body, the wedge-cut defining a sloped portion; and attenuating the at least one acoustic signal with the sloped portion.

Statement 16. The method of any one of the statements 13-15, wherein the acoustic signals are transmitted and/or received from a center of each of the acoustic transducers.

Statement 17. The method of any one of the statements 13-16, wherein the acoustic signals are not transmitted and/or received from a center of each of the acoustic transducers.

Statement 18. The method of any one of the statements 13-17, wherein the at least one acoustic signal is transmitted and/or received with a piezoelectric ceramic or a piezoelectric composite.

Statement 19. The method of any one of the statements 13-18, wherein the acoustic transducers are arranged in a pulse-echo configuration.

Statement 20. The method of any one of the statements 13-19, wherein the acoustic transducers are arranged in a pitch-catch configuration.

Although the present disclosure and its advantages have been described in detail, it should be understood that various changes, substitutions, and alterations may be made herein without departing from the spirit and scope of the disclosure as defined by the appended claims. The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. An acoustic logging tool comprising:
acoustic transducers, each acoustic transducer comprising:
a body;
a piezoelectric element disposed on a first end of the body to receive or transmit at least one signal; and
a wedge-cut disposed on an opposite end of the body, the wedge-cut defining a sloped portion operable to attenuate the at least one signal.

2. The acoustic logging tool of claim 1, wherein the piezoelectric element includes piezoelectric ceramics or composites.

3. The acoustic logging tool of claim 1, wherein the acoustic transducers are arranged in a pitch-catch configuration.

4. The acoustic logging tool of claim 1, wherein the acoustic transducers are arranged in a pulse-echo configuration.

5. The acoustic logging tool of claim 1, wherein the piezoelectric element is disposed at a center of the first end.

6. The acoustic logging tool of claim 1, wherein the piezoelectric element is off-center on the first end.

7. The acoustic logging tool of claim 1, wherein the body includes an elongated portion extending from the piezoelectric element to a side wall of the body.

8. An acoustic logging tool comprising:
acoustic transducers, each acoustic transducer comprising:
a body;
a piezoelectric element disposed on a first end of the body to receive or transmit at least one signal, wherein the first end includes an elongated portion; and
a wedge-cut disposed on an opposite end of the body, the wedge-cut defining a sloped portion operable to attenuate the at least one signal, the opposite end further including a flat portion adjacent to the sloped portion.

9. The acoustic logging tool of claim 8, wherein the piezoelectric element includes piezoelectric ceramics.

10. The acoustic logging tool of claim 8, wherein the acoustic transducers are arranged in a pitch-catch configuration.

11. The acoustic logging tool of claim 8, wherein the acoustic transducers are arranged in a pulse-echo configuration.

12. The acoustic logging tool of claim 8, wherein the piezoelectric element includes piezoelectric composites.

13. The acoustic logging tool of claim 8, wherein the piezoelectric element is disposed on a distal end of the acoustic transducer facing away from a body of the acoustic logging tool.

14. The acoustic logging tool of claim 8, wherein the sloped portion is adjacent to the body of the acoustic logging tool.

15. A method comprising:
transmitting and/or receiving at least one acoustic signal with acoustic transducers, each acoustic transducer comprising a body; a piezoelectric element disposed on a first end of the body and a wedge-cut disposed on an opposite end of the body, the wedge-cut defining a sloped portion; and
attenuating the at least one acoustic signal with the sloped portion.

16. The method of claim 15, wherein the at least one acoustic signal is transmitted and/or received from a center of each of the acoustic transducers.

17. The method of claim 15, wherein the at least one acoustic signal is not transmitted and/or received from a center of each of the acoustic transducers.

18. The method of claim 15, wherein the at least one acoustic signal is transmitted and/or received with a piezoelectric ceramic or a piezoelectric composite.

19. The method of claim 15, wherein the acoustic transducers are arranged in a pulse-echo configuration.

20. The method of claim 15, wherein the acoustic transducers are arranged in a pitch-catch configuration.
